(19) United States
(12) Patent Application Publication
(10) Pub. No.: US 2025/0358591 A1
(43) Pub. Date: Nov. 20, 2025

(54) METHOD AND SYSTEM FOR LOCATING STATIONARY OBJECTS IN AN UNDERGROUND ENVIRONMENT

(71) Applicant: EPIROC ROCK DRILLS AKTIEBOLAG, Örebro (SE)

(72) Inventor: Hans WAHLQUIST, Örebro (SE)

(21) Appl. No.: 18/870,617

(22) PCT Filed: Jun. 2, 2022
(86) PCT No.: PCT/SE2022/050534

§ 371 Date: Nov. 29, 2024

(51) Int. Cl. H04W 4/029; G01S 5/02; H04W 4/40; H04W 4/80

(52) U.S. Cl. CPC H04W 4/029; G01S 5/0249; G01S 5/0295; H04W 4/40; H04W 4/80

(57) ABSTRACT

A method for determining a position of a stationary object in an underground environment, wherein the underground environment includes infrastructure for positioning of moving objects, the method including: broadcasting, by a transmitter arranged on the stationary object, a signal; detecting, by a receiver provided in a first moving object, the presence of the stationary object by receiving the signal; determining a position of the first moving object at a time at which the stationary object was detected; recording a position of the stationary object based on the determined position of the first moving object together with a time stamp indicating the time at which the stationary object was detected; and assigning a position to the stationary object based on the recorded position. A corresponding system is also disclosed.

### TECHNICAL FIELD

The present invention relates generally to a method and system for determining the position of a stationary object in an underground environment.

### BACKGROUND ART

Working in underground environments presents many technical challenges. The underground environments comprise vast networks of ever-changing tunnels and shafts, and thick mountain walls make connectivity and communication difficult.

Therefore, advanced systems for positioning, tracking and controlling machines and people are under constant development, and is a technical field where advancements are continuously presented. Such systems, which are designed to increase control of people as well as the most valuable objects in the underground environment, often require a highly developed infrastructure, expensive equipment and generate large amounts of data to be processed.

However, working in underground environments require the use of many additional, often smaller, objects where it is not always motivated to connect the object to an advanced positioning system. Such objects may be for example tools, toolboxes, fire extinguishers and first aid kits. In an underground environment, such as a mine, the number of such objects may amount to many hundreds and objects are constantly added and removed. These objects furthermore differ from for example mining machines in that they are stationary with no means for moving by themselves, however they may nevertheless be moved from time to time which increases the risk that they may get lost in the underground environment. They are also less expensive than mobile mining machines, which is one reason why it may not be motivated to use advanced systems for keeping track of such stationary objects. However, there is still a need to locate the many stationary objects which are needed in everyday work.

### SUMMARY OF INVENTION

An object of the present invention is to overcome at least some of the problems outlined above.

In a first aspect of the disclosure there is provided a method for determining a position of a stationary object in an underground environment, wherein the underground environment comprises infrastructure for positioning of moving objects, the method comprising: broadcasting, by a transmitter arranged on the stationary object, a signal; detecting, by a receiver provided in a first moving object, the presence of the stationary object by receiving the signal; determining a position of the first moving object at a time at which the stationary object was detected; recording a position of the stationary object based on the determined position of the first moving object together with a time stamp indicating the time at which the stationary object was detected; and assigning a position to the stationary object based on the recorded position.

The method according to the present disclosure enables positioning of objects without having to connect them directly to an advanced, high precision positioning system which is common in underground environments. The objects are instead connected in two steps, first by being detected by another object which is connected to a high precision positioning system, and secondly positioning that connected object. The advantage is a method which is adapted for positioning of a large number of objects at low cost by using pre-existing infrastructure in the underground environment. The advantage is furthermore that the method is less data intensive, at least due to the fact that the stationary object is only positioned when it is detected by the moving object.

In one embodiment, the recorded position may be the same position as the position of the first moving object. In one embodiment, the recorded position may be another position than the first moving object. In one embodiment, the recorded position may be based on a direction, detected by the receiver, from which the signal is broadcasted. In one embodiment, the recorded position may be based on a strength of the broadcasted signal, detected by the receiver. In one embodiment, the position may be based on the position of the first moving object in which the strength of the broadcasted signal is the greatest. In one embodiment, the recorded position may be based on a change in direction and/or signal strength. In one embodiment, the recorded position may be an area. In one embodiment, the area may be based on the determined position of the first moving object, expanded with a radius equal to a range of the broadcasted signal.

In one embodiment the method may comprise associating an uncertainty value to the recorded position of the stationary object.

Since the position of the stationary object is recorded when its presence is detected by a moving object, recorded positions will be generated originating from different moving objects at different times, and there is therefore a need to assess which position recording is the most certain. One advantage is that the uncertainty value may be utilized to weight a plurality of position recordings against each other. Another advantage is that the uncertainty value may be utilized to statistically determine the uncertainty of the assigned position.

In one embodiment the uncertainty value may be based on the time elapsed from the time stamp, an accuracy of the determined position of the first moving object and/or an identity of the first moving object.

In one embodiment the method may comprise updating the uncertainty value whenever there is a change in the time elapsed from the time stamp, an accuracy of the determined position of the first moving object and/or an identity of the first moving object.

The uncertainty of the recorded position may be increased, when the elapsed from the time stamp increases. Thereby it is possible to distinguish between older and more recent position recordings, wherein an older position recording may be less likely to be accurate. The uncertainty of the recorded position may reflect an accuracy of the position determination of the moving object. The accuracy could for example be based on which system is used to position the moving object, or if said system indicates that the position determination is not sufficient. The uncertainty of the recorded position may be dependent on the type of moving object, e.g., if the moving object is a person or a mining machine. A higher uncertainty may for example be associated with a person compared to a mining machine.

In one embodiment the infrastructure for positioning of moving objects may comprise a plurality of access points (AP) arranged at known positions in the underground environment, and wherein determining the position of the first moving object may comprise comparing a signal strength of two or more access points measured from the first moving object. In one embodiment the access points are connected to e.g., a local area network (LAN).

In one embodiment, determining the position of the first moving object may be through triangulation or trilateration.

In one embodiment determining the position of the first moving object may comprise determining a movement path of the first moving object by tracking movements of the first moving object; and comparing the tracked movement with possible movement paths for the first moving object in the underground environment. This type of high precision positioning system is suitable for underground environments where the possible movement paths are limited and furthermore clearly defined.

In one embodiment the method may comprise detecting, by a receiver provided in a second moving object, the presence of the stationary object by receiving the signal; determining a position of the second moving object at a time at which the stationary object was detected; recording a position of the stationary object based on the determined position of the second moving object together with a time stamp indicating the time at which the stationary object was detected; and associating an uncertainty value to the recorded position of the stationary object.

In one embodiment the method may comprise comparing the uncertainty values of a plurality of position recordings for the stationary object, estimating a probability of the position of the stationary object, based on the comparison.

In one embodiment, the first and second moving object may be the same moving object. In this way, a new position of the stationary object may be recorded each time the same moving object passes by the stationary object.

In one embodiment, the method may comprise detecting, by a plurality of receivers provided in a respective moving object, the presence of the stationary object by receiving the signal, determining a position of each respective moving object at a time at which the stationary object was detected by the respective receiver; recording a position of the stationary object based on the determined position of each respective moving object together with a time stamp indicating the time at which the stationary object was detected; and associating an uncertainty value to the recorded position of the stationary object. As such, a plurality of positions of the stationary object is recorded, wherein the recorded positions are based on positions of a plurality of moving objects.

By recording a plurality of positions, originating from a first, second or a plurality of moving objects, a data set is generated which may be used to statistically determine a position of the stationary object. By assigning an uncertainty value to each recorded position they may be weighted. As the assigned uncertainty value changes over time, a more accurate position may be associated with the stationary object.

In one embodiment, detecting the presence of the stationary object may comprise detecting when the moving object is within a predetermined distance of the stationary object.

In one embodiment, the predetermined distance is determined by a range of the broadcasted signal from the stationary object.

In one embodiment, the method may comprise communicating the position of the stationary object to a device of a user.

In one embodiment the assigned position of the stationary object is communicated to a smart phone or a tablet, such that a user who is looking for the object, may retrieve the position in real time.

In one embodiment the position of the stationary object is communicated to a computer for further processing.

In a second aspect of the disclosure, there is provided a computer program comprising instructions which, when the program is executed by a computer, cause the computer to carry out the method according to the first aspect.

In a third aspect of the disclosure there is provided a computer-readable medium comprising instructions which, when executed by a computer, cause a computer to carry out the method according to the first aspect.

In a fourth aspect of the disclosure there is provided system for determining a position of a stationary object in an underground environment, wherein the underground environment comprises infrastructure for positioning of moving objects, the system comprising: a transmitter arranged to be mounted on the stationary object and configured to broadcast a signal; a first receiver arrangeable on a first moving object and configured to receive the signal broadcasted by the transmitter; processing circuitry; and a memory, wherein said memory contains instructions executable by said processing circuitry, wherein the system is operative for: detecting the presence of the stationary object by receiving the signal; determining a position of the first moving object at a time at which the stationary object was detected; recording a position of the stationary object based on the determined position of the first moving object together with a time stamp indicating the time at which the stationary object was detected; and assigning a position to the stationary object based on the recorded position.

One advantage is that a transmitter may be easily mounted on a stationary object, when it is introduced to the underground environment.

In one embodiment, the transmitter may be a Bluetooth transmitter, and the at least one receiver may be a Bluetooth receiver. In one embodiment, the transmitter may be an Ultra-Wideband transmitter. In one embodiment, the transmitter may be a transmitter for Radio-Frequency Identification (RFID). In one embodiment, the transmitter may be any transmitter of radio signals.

One advantage of having a radio signal transmitter is that the transmitter may be space efficient, cost efficient and energy efficient, thereby providing a low-cost system for positioning of a large number of objects in an underground environment with a long service life.

In one embodiment, the first receiver and/or the processing circuitry and memory may be comprised in a handheld unit, such as a consumer tablet or smartphone device. In one embodiment, the first receiver and/or the processing circuitry and memory may be comprised in a vehicle of the underground environment, such as a mining machine.

In one embodiment, the system may comprise a second receiver arrangeable on a second moving object and configured to receive the signal broadcasted by the transmitter, wherein the system may be further operative for: detecting, by the second receiver, the presence of the stationary object by receiving the signal; determining a position of the second moving object at a time at which the stationary object was detected; recording a position of the stationary object based on the determined position of the second moving object together with a time stamp indicating the time at which the stationary object was detected.

### Definitions

Moving object: An object which is intended to move around in the underground environment, such as a vehicle or a person. In other words, a moving object comprises (or is attached to) means for propulsion. In the context of the present disclosure, a moving object could also be an object carried by a vehicle or person, such as a mobile device. The moving object is furthermore often connected to a high precision positioning system. This is because there is often a need to know a position of the moving object essentially at all times, and with a high precision. This in turn, is because the moving object is often associated with a high value such as a high monetary value or due to a matter of safety.

Stationary object: An object which is not intended to move around in the underground environment. In other words, a stationary object does not comprise means for self-propulsion. However, the stationary object may be moved, for example when it is used. The stationary object may for example be used by many different users, thus it may easily get lost. In an underground environment, such as a mine, the stationary object may be any object such as a tool or toolbox, safety equipment such as a fire extinguisher or first aid kit, an electrical cabinet, a battery, a battery charger or charging station, fuel, fuel containers, gates etc.

### BRIEF DESCRIPTION OF DRAWINGS

The invention is now described, by way of example, with reference to the accompanying drawings, in which:

FIG. 1 illustrates a system according to the present disclosure in an underground environment.

FIG. 2 illustrates a system according to the present disclosure in an underground environment.

FIG. 3 illustrates a method according to the present disclosure.

FIG. 4 schematically illustrates a system according to the present disclosure.

### DESCRIPTION OF EMBODIMENTS

In the following, a detailed description of method and a system for determining a position of a stationary object is provided. In the figures, like reference numerals designate identical or corresponding elements throughout the several figures. It will be appreciated that these figures are for illustration only and do not in any way restrict the scope of the present disclosure.

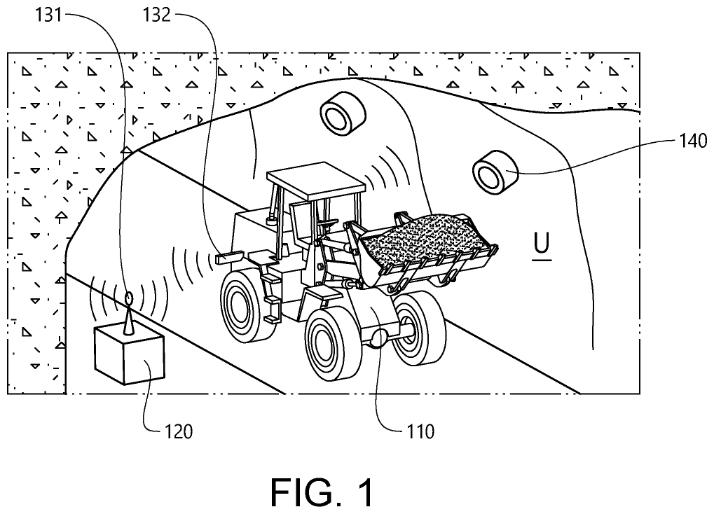

With reference to FIG. 1, there is shown an underground environment U. In the underground environment U, a first moving object 110 in the form of a mining machine is shown. There is furthermore shown a stationary object 120.

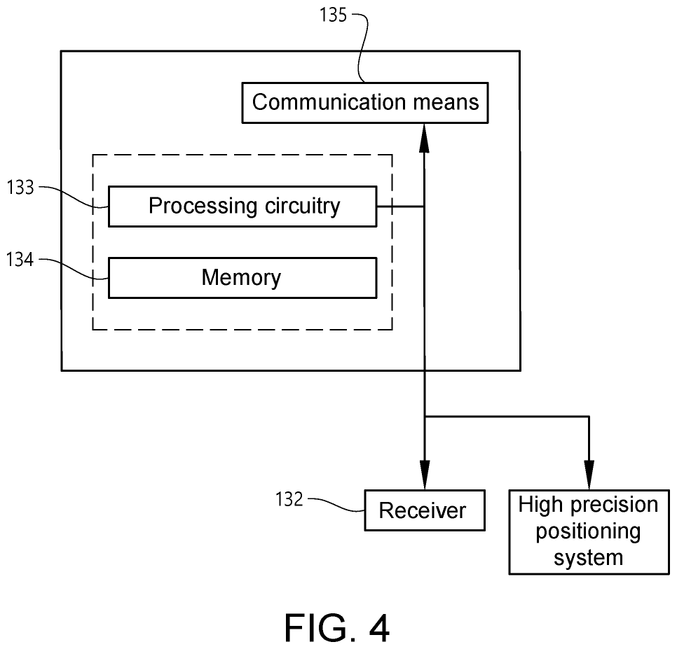

A system 130 according to the disclosure will now be described with reference to FIG. 1. The system 130 generally comprises a transmitter 131 arranged to be mounted on the stationary object 120, a receiver 132 arranged to be mounted on the first moving object 110. The system furthermore comprises processing circuitry 133 and a memory 134 for recording a position of the stationary object 120 and assigning a position to the stationary object 120, will can be seen in FIG. 4. The memory comprises instructions executable by said processing circuitry.

The transmitter 131 is arranged to broadcast a signal. The signal may comprise information making the position of the stationary object 120 known. The transmitter 131 may for example be a Bluetooth transmitter, Ultra-Wideband (UWB) transmitter, a transmitter for Radio-Frequency Identification (RFID) or any transmitter of radio signals.

The transmitter 131 may be attached to an outside of the stationary object 120. The transmitter 131 may for example be attached by means of an adhesive.

The receiver 132 is arranged to detect the signal broadcasted from the transmitter 131 of the stationary object 120. The signal may be detected when the first moving object 110 is with a predetermined distance of the stationary object 120. The predetermined distance may be defined as the range of the signal broadcasted from the transmitter 131. As such, the signal may be detected by the receiver 132 when the first moving object 110 is within range of the signal broadcasted from the transmitter 131 of the stationary object 120.

The system 130 may further comprise means for communicating with a user, such that the recorded and/or assigned position may be retrieved by a user in order to find the stationary object 120. A user may for example retrieve the assigned position from his/her mobile device or form his/her computer.

The first moving object 110 may be positioned by means of a high precision positioning system 130. In FIG. 1, a high precision positioning system comprising access points 140 is arranged in the underground environment U. The access points 140 may communicate with the first moving object 110 to determine a position of the first moving object 110. The position determination may be by means of triangulation or trilateration, wherein the distance between at least two of the access points 140 is known, and the distance between each of the at least two access points 140 and the first moving object 110 is measured. The distance between each of the access points 140 and the first moving object 110 may be determined by measuring the signal strength from the first moving object 110 to the access point.

In another example, the high precision positioning system may comprise means, arranged in the first moving object 110, for determining a movement path of the first moving object 110. Determining a movement path may for example be performed by means of a gyroscope and/or an accelerometer. The determined movement path may be in 2D or 3D. The high precision positioning system further comprises a system for comparing the determined movement path to possible movement paths in the underground environment U. Determining the movement path of the first moving object 110 may be done in real time. Comparing with possible movement paths may be done in real time. Comparing with possible movement paths may comprise selecting a number of possible movement paths, wherein the selection is made by determining a latest known position of the first moving object 110, for example by means of the access points 140 in the underground environment U.

In another example, the underground environment U comprises a plurality of different high precision positioning systems. The first moving object 110 of the underground environment U may be positioned by means of one or several of the plurality of high precision positioning systems. Furthermore, different moving objects in the underground environment U may be positioned by the same or different high precision positioning systems.

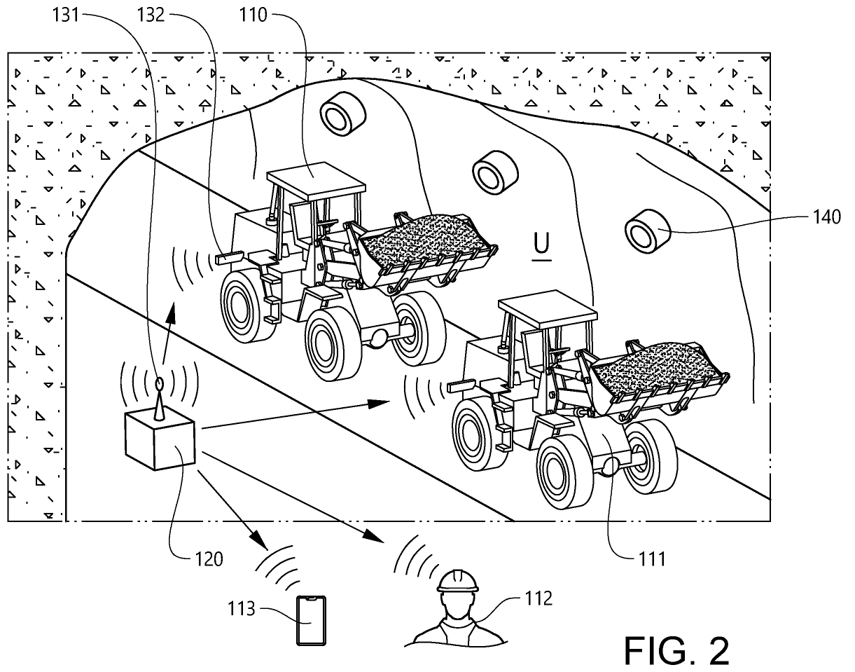

In the underground environment U seen in FIG. 2, the stationary object 120 is shown. The first moving object 110 is furthermore seen in FIG. 2, and additionally a second, a third and a fourth moving object 111,112,113. The first and second moving objects 110,111 are mining machines, the third moving object 112 is a person working in the underground environment U, the fourth moving object 113 is a mobile device. Each of the first, second, third and fourth moving object 110,111,112,113 may pass by the stationary object 120 when they are moving about in the underground environment U. Passing by the stationary object 120 may be defined as coming with range of the signal broadcasted from the transmitter 131 of the stationary object 120. As the signal strength varies with the distance between the transmitter 131 and the receiver 132, this may be used to determine the moment when the first moving object 110 is closest to the stationary object 120. Passing by the stationary object 120 may then be defined as being at a position, within the range of the signal broadcasted from the transmitter 131, at which a strength of the broadcasted signal is the greatest, wherein the signal strength is detected by the transmitter 131. Each of the first, second, third and fourth moving object 110,111,112,113 comprises a receiver arranged to detect the signal broadcasted from the transmitter 131.

Each of the first, second, third and fourth moving object 110,111,112,113 may be positioned by a high precision positioning system. They may be positioned by the same or different high precision positioning systems. They may each be positioned by one or plurality of high precision positioning systems.

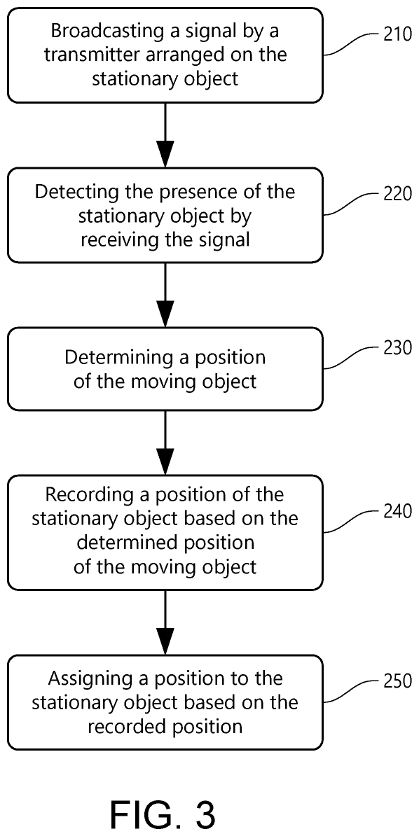

The present disclosure furthermore relates to a method, shown with reference to FIG. 3. The method generally comprises broadcasting 210 a signal from the transmitter 131 on the stationary object 120, detecting 220 the presence of the stationary object 120 by receiving the signal, determining 230 a position of the first moving object 110 at a time at which the stationary object 120 was detected, recording 240 a position of the stationary object 120 based on the determined position of the first moving object 110 together with a time stamp indicating the time at which the stationary object 120 was detected and assigning 250 a position to the stationary object 120 based on the recorded position.

The transmitter 131 arranged on the stationary object 120 is arranged to broadcast a signal to make the position of the stationary object 120 known. The broadcasted signal may be broadcasted continuously. Broadcasting continuously has the advantage that the precision of the recorded position increases. The broadcasted signal may be broadcasted discretely. Broadcasting discretely has the advantage that a battery time of the transmitter increases. The signal may be broadcasted independently of if the receiver 132 arranged on the first moving object 110 is within range of the signal or not.

When the first moving object 110 passes by the stationary object 120, and the receiver 132 is within range of the signal, the receiver 132 detects the presence of the stationary object 120 by detecting the signal.

When the signal is detected, the system 130 is triggered to retrieve a position of the first moving object 110. As such, the position of the first moving object 110 is determined at the time at which the stationary object 120 was detected. A position of the first moving object 110 may be a real time position retrieved from a high precision positioning system. The position may be a last known position of the first moving object 110. The position may be an extrapolated position from a last known position if the first moving object 110. The position may comprise two or more positions retrieved from a respective high precision positioning system.

Based on the determined position of the first moving object 110, a position of the stationary object 120 is recorded to the memory of the system 130. The recorded position may be the same position as the position of the first moving object 110. The recorded position may be another position of the first moving object 110. For example, the receiver 132 arranged on the first moving object 110 may detect a direction from which the signal was received. The receiver 132 may furthermore detect a signal strength of the broadcasted signal. The recorded position of the stationary object 120 may be based on said direction and/or signal strength. The recorded position may be an area. The area may be based on the determined position of the first moving object 110 expanded with a radius equal to a known range of the broadcasted signal.

There is furthermore recorded a time stamp together with the recorded position of the stationary object 120. The time stamp is related to the time at which the signal was detected by the receiver 132. When the time stamp is recorded, a timer may be triggered to start, such that an elapsed time from the time stamp may be measured. Additionally, an identity of the first moving object 110 may be recorded.

The signal broadcasted from the transmitter 131 furthermore may comprise an identity of the stationary object 120 such that the method of the disclosure may be performed for positioning of a plurality of stationary objects. The method may be performed for positioning of a plurality of stationary objects simultaneously.

The method may additionally comprise associating an uncertainty value to the recorded position of the stationary object 120. The uncertainty value has the purpose of describing, for example to a user, the likelihood that the stationary object 120 is at the recorded position. The uncertainty value may describe how large the area is, in which the stationary object 120 may be. The uncertainty value may describe the probability that the stationary object 120 remains in the recorded position or if the probability is higher that it has been moved.

The uncertainty value may be based on a plurality of parameters. The parameters may be weighted, such that one parameter has a larger influence of the uncertainty value than another. One parameter may be the time elapsed since the position was recorded. One parameter may be which high precision positioning system was used to determine the position of the first moving object 110. One parameter may be a correspondence between a plurality of position determinations of the first moving object 110 determined by different high precision positioning systems. One parameter may be the identity of the first moving object 110, wherein one moving object may be weighted differently than another.

The uncertainty value may furthermore be updated whenever a parameter changes. For example, if a longer time has elapsed, the uncertainty value may increase, since the likelihood that the stationary object 120 remains in said position decreases. The uncertainty value may be updated if a high precision position system 130 of the first moving object 110 retroactively updates the position of the first moving object 110, wherein the high precision position system 130 may be triggered to send the updated position to the system of the present disclosure.

The method may comprise detecting, by the receiver provided in the second moving object 111, the presence of the stationary object 120 by receiving the signal broadcasted from the transmitter 131. When the second moving object 111 detects the signal, the position of the second moving object 111 is determined in a way corresponding to what is disclosed above in relation to the first moving object 110. The positions of the first and second moving object 110,111 may be determined by means of the same or different high precision positioning systems.

The first and second moving object 111 may be the same moving object. The first and second moving object 111 may for example be the same moving object if more than one receiver is arranged on the moving object, wherein each receiver detects the signal from the transmitter 131. The first and second moving object 110,111 may for example be the same moving object if the moving object passes the stationary object 120 more than one time, and thus the receiver 132 detects the presence of the stationary object 120 more than one time.

Based on the determined position of the second moving object 111, a position of the stationary object 120 is recorded to the memory of the system 130 together with a time stamp indicating the time at which the stationary object 120 was detected. The method may furthermore comprise associating an uncertainty value to the recorded position.

Each time a moving object passes within range of the signal from the transmitter 131 on the stationary object 120, a position of the stationary object 120 may be recorded such that a plurality of position recordings is generated. The plurality of position recordings may be used to statistically determine the position of the stationary object 120. The plurality of position recordings may each have an associated time stamp and uncertainty value. The associated time stamps and uncertainty values may be used to weight the plurality of position recordings.

The method comprises assigning a position to the stationary object 120 based on the recorded position. Assigning a position may be based on one or a plurality of recorded positions. Assigning a position may be based on the recorded position associated with the lowest uncertainty. Assigning a position may be based on a statistically determined position.

The assigned position may be associated with an uncertainty value. The uncertainty value associated with the assigned position may be the same as an uncertainty value associated with a recorded position. The uncertainty value associated with the assigned position may be a statistically determined value based on a plurality of uncertainty values associated with a plurality of recorded positions.

The assigned position may be communicated to a user. Furthermore, the uncertainty value associated with the position may furthermore be communicated. The uncertainty value describes how likely the user is to find the stationary object 120 at said position.

FIG. 4 schematically displays the processing circuitry and memory for recording a position of the stationary object 120 and assigning a position to the stationary object 120. The system furthermore comprises means for communicating 135 with the receiver 132 of the system 130 when the receiver detects the signal broadcasted from the transmitter 131. The means for communicating 135 is furthermore arranged to retrieve a position of the first, second third and/or fourth moving object 110,111,112,113 from a high precision positioning system of the underground environment U.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a system or method to address each and every problem sought to be solved by the presently described concept, for it to be encompassed hereby.

1. A method for determining a position of a stationary object in an underground environment, wherein the underground environment comprises infrastructure for positioning of moving objects, the method comprising:
broadcasting, by a transmitter arranged on the stationary object, a signal;
detecting, by a receiver provided in a first moving object, the presence of the stationary object by receiving the signal;
determining a position of the first moving object at a time at which the stationary object was detected;
recording a position of the stationary object based on the determined position of the first moving object together with a time stamp indicating the time at which the stationary object was detected; and
assigning a position to the stationary object based on the recorded position.

2. The method according to claim 1, further comprising:
associating an uncertainty value to the recorded position of the stationary object.

3. The method according to claim 2, wherein the uncertainty value is based on the time elapsed from the time stamp, an accuracy of the determined position of the first moving object and/or an identity of the first moving object.

4. The method according to claim 3, further comprising:
updating the uncertainty value whenever there is a change in the time elapsed from the time stamp, an accuracy of the determined position of the first moving object and/or an identity of the first moving object.

5. The method according to claim 1, wherein the infrastructure for positioning of moving objects comprises a plurality of access points arranged at known positions in the underground environment, and wherein determining the position of the first moving object comprises comparing a signal strength of two or more access points measured from the first moving object.

6. The method according to claim 1, wherein determining the position of the first moving object comprises:
determining a movement path of the first moving object by tracking movements of the first moving object; and
comparing the tracked movement with possible movement paths for the first moving object in the underground environment.

7. The method according to claim 1, further comprising:
detecting, by a receiver provided in a second moving object, the presence of the stationary object by receiving the signal;
determining a position of the second moving object at a time at which the stationary object was detected;
recording a position of the stationary object based on the determined position of the second moving object together with a time stamp indicating the time at which the stationary object was detected; and
associating an uncertainty value to the recorded position of the stationary object.

8. The method according to claim 7, comprising:
comparing the uncertainty values of a plurality of position recordings for the stationary object; and
estimating a probability of the position of the stationary object, based on the comparison.

9. The method according to claim 7, wherein the first and second moving object are the same moving object.

10. The method according to claim 1, wherein detecting the presence of the stationary object comprises detecting when the moving object is within a predetermined distance of the stationary object.

11. The method according to claim 1, comprising communicating the position of the stationary object to a device of a user.

12. (canceled)

13. A non-transitory computer readable medium comprising instructions which, when executed by a computer, cause a computer to:
broadcast, by a transmitter arranged on the stationary object, a signal;
detect, by a receiver provided in a first moving object, the presence of the stationary object by receiving the signal;
determine a position of the first moving object at a time at which the stationary object was detected;
record a position of the stationary object based on the determined position of the first moving object together with a time stamp indicating the time at which the stationary object was detected; and
assign a position to the stationary object based on the recorded position.

14. A system for determining a position of a stationary object in an underground environment, wherein the underground environment comprises infrastructure for positioning of moving objects, the system comprising:
a transmitter arranged to be mounted on the stationary object and configured to broadcast a signal;
a first receiver arrangeable on a first moving object and configured to receive the signal broadcasted by the transmitter;
processing circuitry; and
a memory, wherein said memory contains instructions executable by said processing circuitry,
wherein the system is operative for:
detecting the presence of the stationary object by receiving the signal;
determining a position of the first moving object at a time at which the stationary object was detected;
recording a position of the stationary object based on the determined position of the first moving object together with a time stamp indicating the time at which the stationary object was detected; and
assigning a position to the stationary object based on the recorded position.

15. The system according to claim 14, wherein the transmitter is a Bluetooth transmitter, and the at least one receiver is a Bluetooth receiver.

16. The system according to claim 14, wherein the first receiver and/or the processing circuitry and memory are comprised in a handheld unit, such as a consumer tablet or smartphone device.

17. The system according to claim 14, wherein the first receiver and/or the processing circuitry and memory are comprised in a vehicle of the underground environment, such as a mining vehicle.

18. The system according to claim 14, further comprising:
a second receiver arrangeable on a second moving object and configured to receive the signal broadcasted by the transmitter;
wherein the system is further operative for:
detecting, by the second receiver, the presence of the stationary object by receiving the signal;
determining a position of the second moving object at a time at which the stationary object was detected; and
recording a position of the stationary object based on the determined position of the second moving object together with a time stamp indicating the time at which the stationary object was detected.
